(19) United States
(12) Patent Application Publication
(10) Pub. No.: US 2015/0027129 A1
(43) Pub. Date: Jan. 29, 2015

(54) GAS TURBINE WITH ADJUSTABLE COOLING AIR SYSTEM

(71) Applicant: ALSTOM Technology Ltd, Baden (CH)

(72) Inventors: Karsten FRANITZA, Brugg (CH); Peter MARX, Birmenstorf (CH); Ulrich Robert STEIGER, Baden-Daettwil (CH); Andrea BRIGHENTI, Baden (CH)

(21) Appl. No.: 14/498,297

(22) Filed: Sep. 26, 2014

Related U.S. Application Data
(63) Continuation of application No. PCT/EP2013/056344, filed on Mar. 26, 2013.

(30) Foreign Application Priority Data
Mar. 30, 2012 (EP) 12162525.5

(51) Int. Cl. F02C 7/18

(52) U.S. Cl. CPC F02C 7/185
USPC 60/782; 60/806; 60/785

(57) ABSTRACT

In order to improve the cooling of an air-cooled gas turbine in the partial load operating mode it is proposed to provide a connecting line between two cooling air lines with different pressure levels, which connecting line leads from the second cooling air line at a relative high pressure level to the first cooling air line at a relative low pressure level. In this context, a cooling device for cooling an auxiliary cooling air stream, flowing from the second cooling air line into the first cooling air line, and an adjustment element are arranged in the connecting line. In addition to a gas turbine, a method for operating such a gas turbine is the subject matter of the disclosure.

### CROSS-REFERENCE TO RELATED APPLICATIONS

This application claims priority to PCT/EP2013/056344 filed Mar. 26, 2013, which claims priority to European application 12162525.5 filed Mar. 30, 2012, both of which are hereby incorporated in their entireties.

### TECHNICAL FIELD

The present disclosure relates to a method for operating a gas turbine with cooling air lines which are fed from the compressor at different pressure levels, and also to a gas turbine with at least two cooling air lines.

### BACKGROUND

In parallel with the requirements for power and efficiency of the gas turbine, the requirements for cooling of the thermally highly loaded machine components on the one hand and for the design of the cooling system on the other hand increase. Therefore, adequate cooling has to be ensured in the interests of operational reliability for all possible operating conditions of the gas turbine. At the same time, the consumption of cooling air is typically to be limited as far as possible. In EP 62932, it was proposed to cool the components of a gas turbine with steam in a closed circuit. This necessitates a comparatively costly sealing of the components which conduct the cooling steam. At the same time, a purely convective cooling of the components is carried out, dispensing with the effect of a cooling film for reducing the heat input in this case.

The cooling with compressor bleed air still has a number of advantages, wherein the extracted quantity of cooling air is typically to be minimized in the interests of the operating process. Consequently, cooling air systems are being designed more and more on the borderline in order to ensure adequate cooling at the most unfavorable operating point, from the cooling engineering point of view, but to consume no more cooling air than is absolutely necessary in the process. This, on the one hand, means a high sensitivity to deviations of the operating process from the design point of view of the cooling if, for example, the quantities of cooling air vary on account of shifts of the pressure ratios in a machine. On the other hand, an over-cooling of the thermally loaded components results at a number of other operating points, as a result of which the power potentials and efficiency potentials remain unexploited. The permissible operating range within which a reliable operation is possible—wherein all critical components are adequately supplied with cooling air of a suitable temperature level—especially within which the low partial load range and the no-load operation or the running concept with partial load operation or no-load operation is possible, are typically limited by cooling with compressor bleed air, however.

It has therefore occasionally been proposed, for example in EP 1 028 230, to arrange variable throttling points in the cooling air path. DE 199 07 907 proposes to directly adjust the initial pressure of the cooling air by means of rows of variable compressor rotor blades which are arranged directly adjacent to a bleed point for cooling air.

JP 11 182263 and EP 1 128 039 propose to arrange additional compressors in the cooling air path of a gas turbine. In such a way, the total pressure of the cooling air is increased above the pressure which is made available by the compressor.

In addition, a further secondary air system of a gas turbine, in which by means of an external compressor some of the required cooling air can additionally be fed to the individual cooling air tracts, is known from DE 2008 044 436 A1. The use of an external compressor is disadvantageous, however, on account of the increased risk of failure.

It is also known that during operation of the gas turbine below its design point, i.e. below the rated load, an air surplus can occur during the combustion of the fuel. The lower the load to be generated by the gas turbine is, the greater can be the surplus of air provided by the associated compressor for combustion. This leads to the primary zone temperature of the flame in the combustion chamber which is relevant to CO emissions being able to fall below a minimum value. As a result, CO emissions are released at an increased level, which with the existence of predetermined emissions limit values can limit the usable operating range of the gas turbine at partial load. In order to counteract this problem, a gas turbine system and a principle of operation described therein are known from DE 10 2008 044 442 A1. In order to keep the emission from the gas turbine system below a prespecified level, the compressed air which is usually provided by the compressor for combustion is diverted by means of a bypass. The bypass in this case opens either upstream of the bleed point, i.e. into or upstream of the compressor, or also downstream, i.e. into the turbine. This gas turbine system and the described operating method, however, unnecessarily further reduce the efficiency of the gas turbine.

It is also known from US 2010/0154434 A1 to undertake switching in the cooling air supply system during low load operation in such a way that cooling air bleeds of higher pressure are switched to cooling air supply tracts which are supplied with low cooling air pressures during full load operation. It has been proved, however, that the switching processes can especially bring about combustion instabilities and abnormal machine behaviors.

### SUMMARY

The present invention is based on the object of ensuring a reliable operation of the cooling air system of a gas turbine over a wide operating range of the gas turbine without having to accept in return appreciable losses of power or efficiency for operation under design conditions. A low partial load operation up to no-load operation is especially to be ensured without service life losses with low exhaust gas emissions.

It is one aspect of the disclosure to direct cooling air from a second part of the cooling system, which is operated at high pressure, into a first part of the cooling system, which is operated at lower pressure, as soon as the pressure ratios in the first part of the cooling system no longer ensure adequate cooling. This, for example, is the case if for low partial load the variable compressor inlet guide vanes are closed and as a result the pressure build up in the compressor is shifted rearward. A substantial closing of the variable compressor inlet guide vanes is advantageous in order to reduce the air surplus at low partial load or no-load and so to enable a stable, clean combustion. In order to allow use of the cooling air of the second part of the cooling system in the first part, cooling of the cooling air diverted from the second part is carried out. The sufficiently low cooling air temperature is therefore especially necessary since the hot gas temperature at partial load can remain sufficiently high on account of the substantially closed rows of variable compressor inlet guide vanes, which is required for realization of a combustion with low CO emissions. Furthermore, the compressor exit temperature and the compressor bleed temperatures remain relatively high despite the low compressor pressure ratios since with the closing of the variable compressor inlet guide vanes the compressor efficiency falls. This falls significantly in parts of the compressor by more than 40° and up to in excess of 60° compared with the full load position especially in the case of a proposed abrupt closing of the variable compressor inlet guide vanes. In the extreme, the compressor efficiency falls to below a third of the full load efficiency so that the compressor bleed temperatures remain high even in the case of a low pressure ratio. In addition to the hot gas parts of the turbine, the rotor of the gas turbine is also cooled with cooling air. Also, if the thermal load of the turbine at partial load is lower and therefore can possibly be cooled with hotter cooling air, it is to be ensured that the rotor cooling air remains sufficiently cool.

The disclosed gas turbine comprises a compressor, a combustion chamber and a turbine, a rotor and also a cooling air system with at least one first cooling air line, which leads from a low first pressure stage of the compressor to the turbine, and at least one second cooling air line, which leads from a higher, second pressure stage of the compressor to the turbine.

The disclosed gas turbine is distinguished by the fact that the cooling air system of the gas turbine comprises a connecting line which leads from the second cooling air line to the first cooling air line, wherein a cooling device, for cooling an auxiliary cooling air flow which flows from the second cooling air line into the first cooling air line, and a control element, for controlling the auxiliary cooling air flow, are arranged in the connecting line.

According to one embodiment of the gas turbine, a quench cooler is arranged in the connecting line for cooling the auxiliary cooling air flow. For cooling the auxiliary cooling air flow, water can be injected into the quench cooler and evaporates and by means of the evaporation heat leads to cooling of the auxiliary cooling air flow. In addition, as a result of the steam which is produced the cooling air mass flow is increased and the dissipated heat is fed to the turbine with profitable effect.

According to a further embodiment of the gas turbine, a heat exchanger is, arranged in the connecting line for cooling the auxiliary cooling air flow. In this, the auxiliary cooling air flow is cooled by heat exchange. The dissipated heat can be used for fuel preheating or in a water-steam cycle, for example.

According to yet another embodiment of the gas turbine, an injector pump (also referred to as a jet pump) is arranged in the connecting line. The suction-side inlet of the injector pump is connected to the environment and the working fluid inlet is connected to the second cooling air line. By means of the injector pump, ambient air can be drawn, which ambient air is intermixed in the injector pump with the auxiliary cooling air from the second cooling air line and as a result cools this. As a result of the pressure build up in the injector pump, the mixture can be introduced into the first cooling air line and be fed to the turbine for cooling.

In order to ensure that clean air is fed to the cooling system by means of the injector pump, filtered air is fed to the injector pump. According to one embodiment, the suction-side inlet into the injector pump is connected to the environment via a filter house of the gas turbine. A filter house is typically a component part of a gas turbine installation in order to provide clean intake air for the compressor. Alternatively, clean air can also be extracted, for example, at a suitable point of a power plant hall or of a noise abatement hood, wherein corresponding safety regulations are then to be observed.

According to one embodiment, a quench cooler, a heat exchanger and an injector pump are provided singly or in combination. For example, it can be advantageous to first cool the auxiliary mass flow by quench cooling, and therefore to increase the mass flow, before this is directed as working medium into an injector pump. In addition, a combination with a heat exchanger, for example, is advantageous in order to carry out cooling by means of quench cooling or by means of heat exchange, depending on the availability of water.

According to a further embodiment of the gas turbine, a check valve is arranged in the first cooling air line between the compressor and the connection of the connecting line to said first cooling air line, which check valve prevents a backflow of auxiliary cooling air from the second cooling air line through the first cooling air line into the compressor. Any type of non-return valve or flap valve, which comprises a closing element which is closed in one direction and opened in the other direction by a flowing fluid, is to be understood by check valve in this case.

Alternatively to the check valve, or in combination with the check valve, a cooling air control element can be arranged in the first cooling air line between the compressor and the connection of the connecting line to the first cooling air line, by means of which the first cooling air line can be shut off between the compressor and the connecting line. A command for the shutting off can be initiated as a result of a differential pressure measurement, for example, which indicates a backflow of auxiliary cooling air. A suitable differential pressure measurement is, for example, the difference between the pressure at the cooling air bleed point, to which the first cooling air line is connected, and the pressure at the connecting point at which the connecting line opens into the first cooling air line.

In addition to the gas turbine, a method for operating such a gas turbine is a subject of the disclosure. The gas turbine comprises a compressor with a row of variable compressor inlet guide vanes, a combustion chamber and a turbine and also a cooling air system with at least one first cooling air line, which leads from a first pressure stage of the compressor to the turbine, and at least one second cooling air line, which leads from a higher, second pressure stage of the compressor to the turbine.

According to one embodiment of the disclosed method, at partial load of the gas turbine a row of variable compressor inlet guide vanes is closed compared with a full load position and an auxiliary cooling air flow from the second cooling air line is directed via a connecting line, which leads from the second cooling air line to the first cooling air line. In this case, this auxiliary cooling air flow is cooled in a cooling device before being introduced into the first cooling air line and the mass flow of this auxiliary cooling air flow is controlled by means of a control element.

As result of closing the variable compressor inlet guide vanes, the pressure build up in the compressor is shifted so that the pressure margin from the first compressor bleed point, to which the first cooling air line is connected, is no longer adequate for reliable cooling of the turbine. As a result of the auxiliary cooling air flow, the pressure in the first cooling air line is increased. The bleed flow from the first compressor bleed point is reduced in this case. As a result of this reduction, the pressure at the compressor bleed point increases. With substantial closing of the rows of variable compressor inlet guide vanes, however, a negative pressure margin occurs so that no bleed of cooling air from the first compressor bleed point is possible.

According to one embodiment of the method, the auxiliary cooling air flow is cooled in a quench cooler, which is arranged in the connecting line, by means of water injection into the auxiliary cooling air flow. Not only the auxiliary cooling air flow is advantageously cooled as a result, but its mass flow is also increased.

According to a further embodiment of the method, the auxiliary cooling air flow is cooled in a heat exchanger which is arranged in the connecting line. The dissipated heat can be used with profitable effect, e.g. as process heat.

According to yet another embodiment of the method, the auxiliary cooling air flow is introduced into the working medium inlet of an injector pump, which is arranged in the connecting line, and ambient air is drawn in via the suction-side inlet of the injector pump. As a result of the intermixing with the inducted ambient air, the temperature of the resulting auxiliary cooling air flow is reduced in the process. Furthermore, the mixture of ambient air and auxiliary cooling air flow is introduced into the first cooling air line. In addition to auxiliary cooling air at reduced temperature, as a result of adding ambient air the requirement for cooling air at high pressure from the second cooling air line is reduced and therefore the influence upon the power and efficiency of the gas turbine is minimized.

In order to ensure reliable cooling of the turbine, according to one embodiment of the method the control element for controlling the auxiliary cooling air flow is opened providing the row of variable compressor inlet guide vanes is closed to an extent which is more substantial than a first limit value of the compressor inlet guide vane position. Since the pressure build up in the compressor is dependent not only on the position of the variable compressor inlet guide vanes but also on other operating parameters, such as the ambient temperature, contamination or aging of the compressor, or, for example, water injection into the compressor, this first limit value is, for example, selected to be of a magnitude which makes sure that a sufficient pressure margin is always ensured in the first cooling air line regardless of the operating conditions. The first limit value lies, for example, within the range of a row of variable compressor inlet guide vanes which are closed by 30° to 50° compared with the full load point.

As a result of a substantial closing of the variable compressor inlet guide vanes, depending on closing angle, design of the compressor and position of the first compressor bleed point, a sharp pressure drop, and in the extreme even a negative pressure in relation to the environment, can occur at the first compressor bleed point. In order to prevent a backflow of auxiliary cooling air into the compressor, according to one embodiment of the method the control element for controlling the auxiliary cooling air flow is opened providing the row of variable compressor inlet guide vanes is closed to an extent which is more substantial than a second limit value of the compressor inlet guide vane position. The second limit value lies, for example, within the range of a row of variable compressor inlet guide vanes which are closed by more than 40° to 60° compared with the full load point.

According to a further embodiment of the method, in order to prevent a backflow of auxiliary cooling air into the compressor a pressure difference which is indicative for the backflow is measured. As an indicative pressure difference, for example the difference between the pressure at a compressor cooling air bleed point, to which the first cooling air line is connected, and the pressure at the connecting point at which the connecting line opens into the first cooling air line, are measured. The cooling air control element is closed as soon as this pressure difference becomes negative.

The control valve for controlling the auxiliary cooling air flow which is directed from the second cooling air line into the first cooling air line and also the controlling of the cooling air control valve in the first cooling air line can also be carried out as a function of the operating conditions of the gas turbine with the aid of approximation equations or “lookup tables”. This can be carried out as a function of ambient temperature, the compressor inlet temperature or the aerodynamic speed, for example.

For many power plant operators, it is advantageous to operate the gas turbine without load, if the no-load emissions of the gas turbine allow this, in order to avoid start-stop cycles or to enable fast loading up.

Conventionally, the hot gas temperature is sharply reduced at low partial load and no-load so that in particular the low pressure section of the gas turbine is hardly thermally loaded. On account of the proposed principle of operation with rows of variable compressor inlet guide vanes closed to a substantial extent, the hot gas reduction can be minimized so that the hot gas temperature (or turbine inlet temperature) remains high and the turbine exhaust temperature also remains high. The high turbine exhaust temperature is particularly important for operation of a combined cycled power plant with a downstream boiler from which a steam turbine is fed, since the steam section of the combined cycled power plant can therefore remain in operation and in particular can be loaded up at any time with stopping points. Furthermore, with the high exhaust gas temperature the thermal cyclic load is reduced or totally avoided as a result of an unloading of the components of the water-steam cycle to low partial load or no-load.

According to one embodiment of the method, the turbine exhaust gas temperature is lowered at partial load and no-load by closing the row of variable compressor inlet guide vanes not more than 80 degrees compared with the full-load turbine exhaust gas temperature. In particular, the turbine exhaust gas temperature according to one embodiment can be held at least 80° of the full-load turbine exhaust gas temperature (measured in ° C.).

Furthermore, the work output of the turbine is minimized as a result of the reduced pressure ratio. According to one embodiment of the method, the pressure ratio of the turbine at no-load is adjusted to a quarter of the full-load pressure ratio or to an even smaller pressure ratio.

In addition to the described embodiments, the combination of the methods with other known measures for the reduction of CO emissions at partial load is conceivable. Especially conceivable are measures for increasing the compressor inlet temperature by means of an air preheater (intake air preheating) and/or an anti-icing system and also my means of exhaust gas recirculation.

The disclosure can be applied without limitation to gas turbines with one combustion chamber and also to gas turbines with sequential combustion, as are known from EP0718470, for example. It is even specifically suitable for gas turbines with sequential combustion since in the case of such gas turbines a first combustion chamber and a first turbine are typically cooled by a high-pressure cooling system, and a second combustion chamber and a second turbine are cooled by one or more cooling systems of an intermediate and lower pressure stage.

### BRIEF DESCRIPTION OF THE DRAWINGS

Preferred embodiments of the disclosure are described in the following text with reference to the drawings which serve purely for explanation and are not to be interpreted as being limiting. In the drawings:

FIG. 1 shows a schematic view of a gas turbine with a cooling air system with two pressure levels according to the prior art;

FIG. 2 shows a schematic view of a gas turbine with a connecting line between the two cooling air systems and a cooling device for an auxiliary cooling air flow, and a control element;

FIG. 3 shows a schematic view of a gas turbine with a quench cooler for cooling the auxiliary cooling air flow;

FIG. 4 shows a schematic view of a gas turbine with a heat exchanger for cooling the auxiliary cooling air flow;

FIG. 5 shows a schematic view of a gas turbine with an injector pump for adding ambient air and for cooling the auxiliary cooling air flow.

The exemplary embodiments and figures are to be understood as being only instructive, and are in no way intended to serve as the limitation of the disclosure which is characterized in the claims.

### DETAILED DESCRIPTION

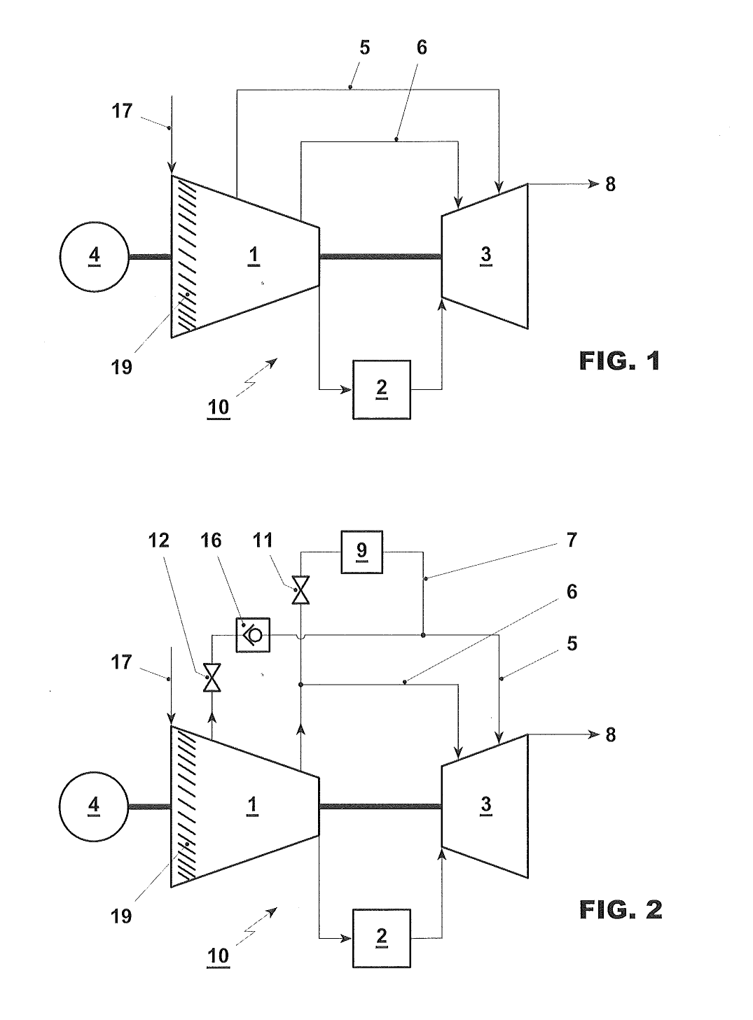

FIG. 1 shows in a schematic view the essential elements of a gas turbine with a cooling air system with two pressure levels. The gas turbine 10 comprises a compressor 1, wherein the combustion air which is compressed therein is fed to a combustion chamber 2 and combusted with fuel there. The hot combustion gases are then expanded in a turbine 3. The useful energy which is generated in the turbine 3 is then converted into electric energy by means of a generator 4, for example, which is arranged on the same shaft.

The hot exhaust gases 8 which issue from the turbine 3, for optimum utilization of the energy still contained therein, are typically used in a heat recovery steam generator (HRSG—not shown) for producing steam. This can be converted in a steam turbine into usable mechanical power or be used as process steam, for example.

The depicted gas turbine 10 comprises a cooling air system with two pressure stages. From a first pressure stage of the compressor 1, a first cooling air line 5 directs cooling air to the turbine 3, in which this cooling air cools thermally loaded components in the low-pressure section of the turbine 3. From a higher, second pressure stage of the compressor 1, a second cooling air line 6 directs cooling air to the turbine 3, which cools thermally loaded components in the high-pressure and/or intermediate-pressure section of the turbine 3. The combustion chamber is similarly cooled with high-pressure cooling air (not shown).

Shown in FIG. 2 is a schematic view of a gas turbine 10 in which a connecting line 7 is arranged between the first cooling air line 5 and the second cooling air lines 6. In the connecting line provision is made for a cooling device 9 for an auxiliary cooling air flow and for a control element 11. With the control element 11 open, an auxiliary cooling air flow flows from the second cooling air line 6 through the connecting line 7 and the cooling device 9 into the first cooling air line 5. By means of the auxiliary cooling air flow the cooling air pressure in the first cooling air line 5 can be increased if, for example, this drops below a necessary minimum pressure as a result of closing the row of variable compressor inlet guide vanes 19.

Since the cooling air, which is diverted from the first compressor bleed point, is compressed only to a low pressure level—typically to a fifth up to a third of the compressor exit pressure—this cooling air is cool relative to the compressor exit temperature. The temperature at the first bleed point typically remains below 200° C., depending on design conditions and operating conditions. The cooling air of the second cooling air line 6 is at a significantly higher pressure level or even extracted at the compressor exit. Accordingly, this cooling air is significantly hotter than the cooling air of the first compressor bleed point. It is typically higher than 250° C. and can exceed 500° C. Since the cooling air of the second cooling air line 6 is hotter, this has to be cooled in the cooling device 9 before it is fed to the first cooling air line 5 in order to ensure that the parts cooled by this auxiliary cooling air flow, or by a mixture of cooling air of the first compressor bleed point and auxiliary cooling air, achieve their service life.

Only by the combination of cooling and controlled feed of auxiliary cooling air can a longer partial load operation with the row of variable compressor inlet guide vanes 19 substantially closed (row of variable compressor inlet guide vanes closed by more than 30°, typically even by more than 40° compared with the full-load position), be realized without service life losses. This is especially necessary for so-called low partial load operating concepts. These operating concepts are needed in order to be able to operate a gas turbine at very low load with a low power demand of the electricity network without shutting down. A load which is less than 40% of the full load is typically referred to as low partial load. Depending on the network requirements, it is advantageous to reduce the load below 30% or even to below 10% of the full load.

In order to control the cooling air supply via the first cooling air line 5, a cooling air control element 12 is arranged in the cooling air line 5 between the first compressor bleed point and the connecting line 7. By means of this, the cooling air mass flow can be controlled or even completely stopped if at low partial load the low-pressure cooling is realized entirely by means of the auxiliary cooling air. Furthermore, in the cooling air line 5, between the first compressor bleed point and the connecting line 7, provision is made for a check valve 16 which prevents a backflow of auxiliary cooling air into the compressor during substantial closing of the variable compressor inlet guide vanes. This would lead to a loss of power and efficiency of the gas turbine 10 and could lead to a detrimental heating of the compressor 1.

A cooling air control valve is also conceivable in the second cooling air line 6, wherein this would only be used as restrictor dependent upon operating state and not as a shut-off valve (not shown).

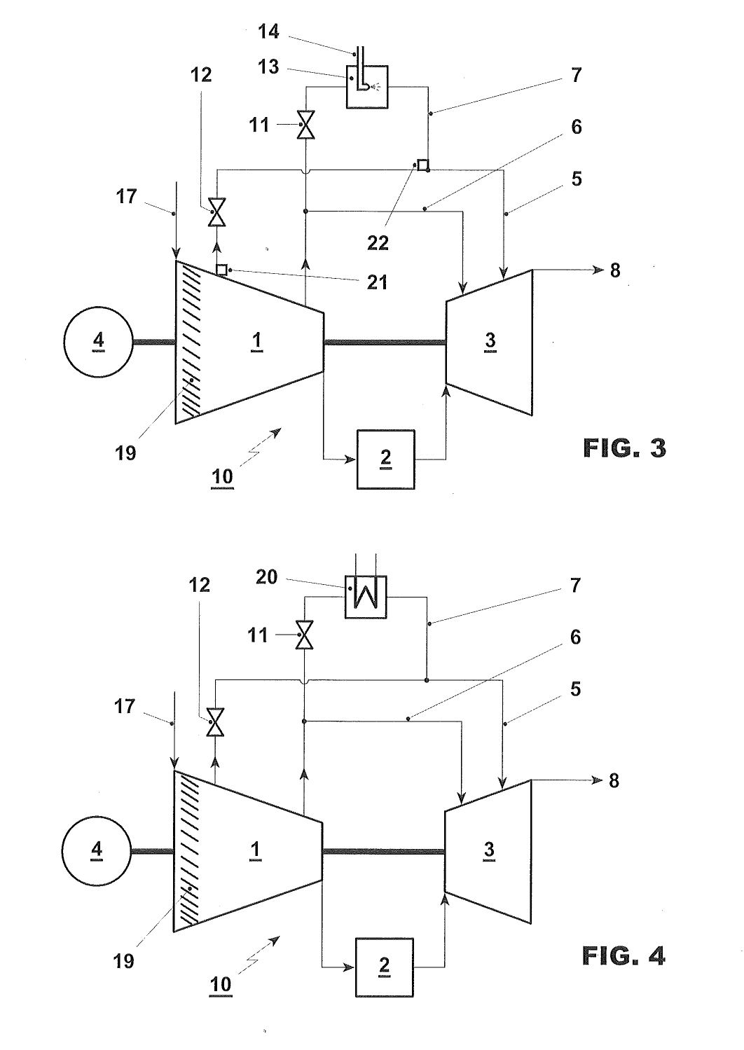

Shown in FIG. 3 is a schematic view of a gas turbine 10 with a quench cooler 13 for cooling the auxiliary cooling air flow. In the quench cooler 13, water is injected via a water injector 14 into the auxiliary cooling air, evaporates in the quench cooler 13 and cools the auxiliary cooling air in the process. The auxiliary cooling air flow which is increased by the steam which is produced during the quench cooling is further directed through the connecting line 7 into the first cooling air line 5 and used for cooling the low-pressure section of the turbine 3.

FIG. 4 schematically show a view of a gas turbine 10 with a heat exchanger 20 for cooling the auxiliary cooling air flow. The auxiliary cooling air flow is cooled by heat exchange to a temperature at which the auxiliary cooling air flow in the low-pressure cooling system ensures the service life of the low-pressure section of the turbine 3. The heat is dissipated by means of air-to-air heat exchange or by means of air-to-water heat exchange, for example.

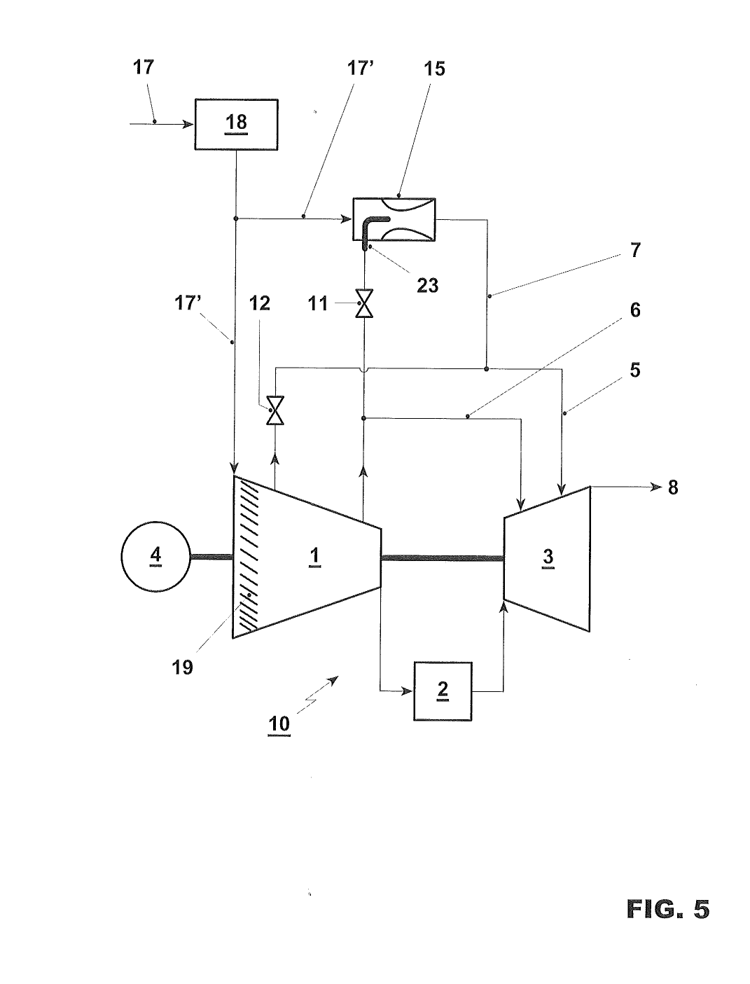

FIG. 5 schematically shows a view of a gas turbine in which an injector pump 15 Is arranged in the connecting line 7. Via the control element 11, auxiliary cooling air from the second cooling air line 6 can be fed to the working medium inlet 23 of the injector pump 15. The working medium discharges at high speed through a nozzle which is arranged for example in the narrowest cross section of a convergent-divergent flow cross section of the injector pump 15. The suction-side inlet of the injector pump 15 is connected to the environment via the filter house 18 of the gas turbine 10. In the injector pump 15, a total pressure increase of the inducted ambient air 17′ occurs, as a result of which this ambient air together with the auxiliary cooling air which is diverted from the second cooling air line can be introduced into the first cooling air line. By intermixing with ambient air 17′ and by selecting a corresponding mass ratio of ambient air and auxiliary cooling air the mixture temperature is adapted to the requirements of the low-pressure cooling air system.

Furthermore, the invention also enables the quantity of cooling air, for example as a function of the hot gas temperature in the region of the components to be cooled, to be reduced to a minimum which is required for operating reliability, and to be correspondingly increased at high gas turbine load.

Naturally, a gas turbine can also be equipped with three or more pressure stages.

In the light of the preceding embodiments, a large number of possible embodiments of the invention which are characterized in the claims are opened up to the person skilled in the art.

1. A gas turbine comprising a compressor, a combustion chamber, a turbine and a cooling air system which comprises at least one first cooling air line, which leads from a first pressure stage of the compressor to the turbine, and at least one second cooling air line, which leads from a higher, second pressure stage of the compressor to the turbine,
wherein the cooling air system of the gas turbine comprises a connecting line which leads from the second cooling air line to the first cooling air line, wherein a cooling device, for cooling an auxiliary cooling air flow which flows from the second cooling air line into the first cooling air line, and a control element are arranged in the connecting line.

2. The gas turbine as claimed in claim 1, further comprising in the connecting line a quench cooler is arranged as a cooling device for cooling the auxiliary cooling air flow.

3. The gas turbine as claimed in claim 1, further comprising a heat exchanger is arranged in the connecting line as cooling device for cooling the auxiliary cooling air flow.

4. The gas turbine as claimed in claim 1, further comprising an injector pump is arranged in the connecting line cooling device, the suction side inlet of which injector pump is connected to the environment and the working medium inlet of which is connected to the second cooling air line so that ambient air can be drawn in, and a mixture of ambient air and auxiliary cooling air from the second cooling air line can be directed via an outlet of the injector pump through the connecting line and further into the first cooling air line.

5. The gas turbine as claimed in claim 4, wherein the suction-side inlet into the injector pump is connected to the environment via a filter house of the gas turbine.

6. The gas turbine as claimed in claim 1, further comprising a check valve is arranged in the first cooling air line between the compressor and the connection of the connecting line to the first cooling air line, preventing a backflow of auxiliary cooling air from the second cooling air line into the compressor.

7. The gas turbine as claimed in claim 1, further comprising a cooling air control element is arranged in the first cooling air line between the compressor and the connection of the connecting line to the first cooling air line, by means of which the first cooling air line can be shut off between the compressor and the connecting line.

8. A method for operating a gas turbine which comprises a compressor with a row of variable compressor inlet guide vanes, a combustion chamber and a turbine, wherein the gas turbine comprises a cooling air system with at least one first cooling air line, which leads from a first pressure stage of the compressor to the turbine, and at least one second cooling air line, which leads from a higher, second pressure stage of the compressor to the turbine,
comprising at partial load of the gas turbine a row of variable compressor inlet guide vanes is closed compared with a full-load position and an auxiliary cooling air flow from the second cooling air line is directed via a connecting line, which leads from the second cooling air line to the first cooling air line, wherein this auxiliary cooling air flow is cooled in a cooling device before being introduced into the first cooling air line and the mass flow of this auxiliary cooling air flow is controlled by means of a control element.

9. The method for operating a gas turbine as claimed in claim 8, wherein the auxiliary cooling air flow is cooled in a quench cooler, which is arranged in the connecting line, by means of water injection.

10. The method for operating a gas turbine as claimed in claim 8, wherein the auxiliary cooling air flow is cooled in a heat exchanger which is arranged in the connecting line.

11. The method for operating a gas turbine as claimed in claim 8, wherein the auxiliary cooling air flow is introduced into a working medium inlet of an injector pump which is arranged in the connecting line, ambient air is drawn in via the suction-side inlet of the injector pump and by intermixing with the ambient air the temperature of the auxiliary cooling air flow is reduced and the mixture of ambient air and auxiliary cooling air flow is introduced into the first cooling air line.

12. The method for operating a gas turbine as claimed in claim 8, wherein the control element for controlling the auxiliary cooling air flow is open providing the row of variable compressor inlet guide vanes is closed to an extent which is more substantial than a first limit value of the variable compressor inlet guide vanes position.

13. The method for operating a gas turbine as claimed in claim 8, wherein a cooling air control element which is arranged in the first cooling air line between the compressor and the connection of the connecting line is closed providing the row of variable compressor inlet guide vanes is closed to an extent which is more substantial than a second limit value of the variable compressor inlet guide vanes position.

14. The method for operating a gas turbine as claimed in claim 8, wherein the pressure difference between the pressure at a compressor cooling air bleed point, to which the first cooling air line is connected, and the pressure at the connecting point, at which the connecting line opens into the first cooling air line, is measured, and in that the cooling air control element is closed as soon as this pressure difference becomes negative.

15. The method for operating a gas turbine as claimed in claim 8, wherein at low partial below 10% of the full-load power and at no-load the turbine exhaust gas temperature is kept to at least 80% of the full-load turbine exhaust gas temperature by closing the row of variable compressor inlet guide vanes.
